(19) United States
(12) Patent Application Publication
(10) Pub. No.: US 2008/0000837 A1
(43) Pub. Date: Jan. 3, 2008

(54) Water-Softening Product and Process for Its Preparation and Use Thereof

(75) Inventors: Francesc Ardite Ayats, Barcelona (ES); Mark Laing, Beverley (GB); Fabio Corradini, Mira VE (IT); Alberto Simionato, Mira VE (IT); Emanuele Rossetto, Mira VE (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/570,273

(22) PCT Filed: Jun. 13, 2005
(86) PCT No.: PCT/GB05/02323

§ 371 Date: Feb. 28, 2007

(30) Foreign Application Priority Data
Jun. 12, 2004 (GB) 0413136.3

(51) Int. Cl. C02F 5/00; C02F 5/10; C11D 17/04

(52) U.S. Cl. 210/687; 252/176

(57) ABSTRACT

This invention relates to a method of water-softening using a water-softening product and products useful in such methods. The invention describes improved products and processes for their preparation wherein a water-softening composition is held between a water permeable water-insoluble web.

This invention relates to a water-softening product, to a method for its preparation, and to its use in a water-softening method.

It is well known that certain metal compounds, notably calcium compounds, have a significant effect on the properties of water. “Hard” water containing a significant loading of soluble calcium and magnesium compounds form a scum with soap or detergent and may require a larger amount of detergent in order to provide an efficient clean. Scale deposits can readily form from such water, for example on heating or pH change or evaporation. These deposits can be encrustations, or watermarks left on evaporation of water droplets from, especially, a shiny surface. In addition hard water can form encrustations on fabric washed using such water giving a harsh feel to the fabric.

There have been many proposals for the removal of metal ions from aqueous solutions. In the industrial context proposals have included filter beds and polymeric filters for capturing heavy metal ions from an aqueous solution flowing within a passageway. Examples are given in EP-A-992238 and GB-A-20869564. In the domestic context sequestrants can be added to an aqueous washing solution and these can capture metal ions, such as calcium ions. Examples of such sequestrants are given in EP-A-892040.

However, consumers can be sceptical as to the benefits derived from the use of water-softening products since the benefits are not immediately obvious after a single use of the product; the benefits accumulate over time, for example preventing encrustation of heating elements or encrustations onto the fabric. Typically the water-softening product is consumed during the washing process and it is washed away, such as in the use of powder, tablets or liquid products.

In a multi-step washing process, such as that carried out by a clothes washing machine, it can be a problem that the water-softening product is discharged with the waste water, at an intermediate stage of the process, and it is not available for later stages of the washing process, such as the rinse cycle.

WO0218533 and WO0218280 describe water-softening products that are not necessarily consumed during washing processes, because they are not water-soluble, and which are too large to be washed away during any rinsing step.

We have found a simple process for the preparation of water-softening products.

In accordance with a first aspect of the present invention there is provided a process for the preparation of a water-softening product, the process comprising:
a) forming an open sachet from one, two or more water-permeable water-insoluble web;
b) filling the open sachet with a water-softening composition; and
c) sealing the sachet.
   Optional Steps

Preferably the process includes the step of cutting the web(s) to form the open or closed sachet. Most preferably the process includes the step of cutting the closed sachet to form the water-softening product.

A series of additional steps may be performed, in any order and combination; including:
a) distributing evenly the water-softening composition through the sachet;
b) fixing the water-softening composition to itself and/or the wall(s) of the sachet;
c) packaging the sachet into a moisture impermeable package.

We present as a subsequent feature of the invention a water-softening product comprising a container containing a water-softening composition, the container being formed by the closing of a sachet formed from a water permeable water insoluble web.

We further present a method of softening water comprising contacting hard water with a product as defined herein.

A method of softening water may be a method used in a ware washing machine, for example a clothes washing machine or a dishwashing machine. Preferably the product is able to work through the wash and the rinse cycle of the machine; or only in the rinse cycle, or just in the washing cycle.

Alternatively a method in accordance with the invention may be a manual method, for example using a hand-cloth or mop, and an open vessel, for example a bucket or bowl. Thus, the cleaning method could be a method of cleaning a hard surface, for example a window, a tiled surface, shower screen, dirty tableware and kitchenware, a sanitaryware article, for example a lavatory, wash basin or sink, a car (which we regard as a “household article” within the terms of this invention) or a kitchen worktop.

Product Features

By water permeable we mean that the material allows water to pass through, under the conditions in which the product is used. Suitably the material has an air permeability of at least 1000 l/m²/s at 100 Pa according to DIN EN ISO 9237. In addition the web must not be so permeable that it is not able to hold a granular water-softening composition (e.g. greater than 150 microns).

A closed sachet intended for use in a ware washing machine must resist a laundry wash cycle (2 h wash/rinse/spin cycle, 95° C., spinning at 1600 rpm) without opening.

Preferably the water-softening composition is in the form of a compact, preferably firm, “cake” inside the sachet. Preferably, the cake is spread across the interior of the sachet. Ideally, the cake is also attached to either or both inside walls of the sachet, as a “sandwich”. Preferably during the wash, the cake breaks to create a loose amount of granular insoluble materials that can move freely inside the sachet, like in a “tea bag”, that allows the permeating water to be exposed to the entire surface area of the contents of the sachet.

The sachet should not be able to move out of the drum, such as by entering the internal piping of the washing machine and onto the filter. The sachet may comprise a rigid body of sufficient size, i.e. at least 8 mm in one dimension (e.g. it may be a flat rigid shape of at least 8 mm in one dimension); and/or if the sachet is flexible, it is preferably of size at least 120 mm×120 mm.

The product could be discarded after use, or it could be regenerated when certain water-softening agents are used, for example cation exchange resins by using sodium chloride to effect ion exchange, and re-used.

The sachet is preferably flat, i.e. with one dimension, the thickness of the sachet, at least 5 times smaller preferably at least 10 times smaller, ideally at least 30 times smaller than the other two, the width and the length of the sachet (which are the same as each other, corresponding to the diameter of the sachet, should it be circular in plan).

Preferably the sachet covers a surface (i.e. the product of width and length (when the sachet is rectangular) of between 80 to 300 cm², ideally 100 to 200 cm².

The sachet may be placed with the items to be washed in an automatic washing machine.

Alternatively the sachet may pack into the flow pathway for the rinse or wash water of a ware washing machine such that the water is compelled to flow through it.

Water-Softening Composition

The water-softening composition may contain one or more water-softening agents.

Preferably at least one water-softening agent is present which is substantially water-insoluble.

By substantially water-insoluble water-softening agent we mean an agent, more than 50% wt, preferably at least 70% wt, more preferably at least 85% wt and most preferably at least 95% wt, and optimally 100% wt, of which is retained in the product, when the product is used under the most rigorous conditions for which it is intended (90° C.).

The composition could contain a water-soluble solid agent or a dispersible solid agent that is not water-soluble but which can pass through the walls of the container when immersed in water. Such a water-soluble or dispersible solid agent could be, for example, any possible component of compositions with which the product can be used.

Preferably the total amount of water-softening composition is between 5 and 25 g, ideally between 7 and 20 g.

The composition is preferably substantially free of any surfactant and/or a source of active oxygen (whether water-soluble or not). In one embodiment the composition is preferably substantially free of phosphonate compounds, and more preferably is substantially free of any phosphorous-containing compounds. However other embodiments could contain one or more such compounds. By substantially free we mean less than 20% wt, 10% wt, 5% wt, less than 2% wt, less than 1% wt, ideally less than 0.5% wt of such compounds relative to the total weight of the water-softening composition.

Preferably the water-softening composition is of particulate form, or formed from a particulate material. Preferably the particle size distribution of the water-softening composition is <0.2% at <100 microns and/or <0.1% at >2 mm.

Within the water-softening composition may be present an adhesive to fix the composition itself to form a cake and/or to one, at least, of the walls of the sachet, such as, polyethylene, EVA(preferably low melting point), polyamides, polyurethanes, epoxy or acrylic resins added in particulate (e.g. powder or granular) form within the composition. Subsequent heating (by convection or conduction or irradiation, especially with IR or UV) activates the binder within the composition and causes it to form a cake with the product. Preferably through the agency of the melted and cooled/set binder the cake is adhered to both sheets of the sachet.

Water-Insoluble Water-Softening Agent

A water-insoluble agent could comprise polymeric bodies. Suitable forms include beads and fibres. Examples include polyacrylic acid and algins. The water-insoluble agent could alternatively be an inorganic material, for example a granular silicate or zeolite which is retained by the product walls.

Preferably, water-insoluble water-softening agent is present in the water-softening composition in an amount of more than 1%, 5%, 10%, 20%, 30%, 40%, 50%, 60%, 70%, 80%, 90% and 95% wt thereof. Desirable maximum amounts are less than 95%, 90%, 80%, 70%, 60%, 50%, 40%, 30%, 20% and 10% wt, based on the total weight of the water-softening composition. A preferred range is 10-60%, more preferably 20-50%, most preferably 30-40%.

Sequestrant side chains may be grafted onto water-insoluble bodies (such as polymeric bodies), for example using the well-known techniques of radiation grafting or chemical grafting. Radiation grafting is described in WO 94/12545. Chemical grafting is described in GB 2086954A. Alternatively for certain side chains the polymeric bodies may be fabricated (for example melt spun) already bearing the sequestrant side-chains, as described in EP 486934A. In yet other embodiments polymeric bodies not bearing sequestrant side chains may be coated with material which has the side chains. The polymeric bodies may, in effect, be regarded as carrying the side chains by mechanical adhesion. Alternatively they may attach by cross-linking, as described in EP 992283A.

Preferably sequestrant side chains are any side-chains which can be carried by polymeric bodies, and which are able to bind calcium (and preferably other) ions, and whose effectiveness in doing that is not substantially diminished by a cleaning agent. Suitable calcium-binding side-chains include residues of acids, for example of acrylic or methacrylic acid, or carboxylic acids, or of sulphonic acids, or of phosphonic acids. Residues of organic acids are preferred. Particularly preferred are residues of methacrylic or, especially, acrylic acid.

Alternative calcium-binding side chains of polymeric bodies may include amino groups, quaternary ammonium salt groups and iminodicarboxyl groups —N{(CH₂)ₙCOOH}₂, where n is 1 or 2.

Further suitable calcium-binding side chains of polymeric bodies may include acyl groups as described in EP 984095A. These have the formula
—C(O)—X(V)(Z)(M) or —C(O)—X(V)(Z)(S-M′)
where X represents a residue in which one carboxyl group is eliminated from a monocarboxylic acid or dicarboxylic acid;
V represents hydrogen or a carboxyl group;
M represents hydrogen; or 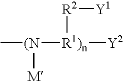
   wherein R¹ represents a residue in which one hydrogen is eliminated from a carbon chain in an alkylene group, R² represents a direct bond or an alkylene group, Y¹ and Y² are the same or different and each represents hydrogen, a carboxyl group, an amino group, a hydroxy group or a thiol group, n is an integer of 1 to 4, M′ represents hydrogen or 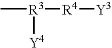
   wherein R³ represents a residue in which one hydrogen is eliminated from a carbon chain in an alkylene group; R⁴ represents a direct bond or an alkylene group, Y³ and Y⁴ are the same or different and each represents hydrogen, a carboxyl group, an amino group, a hydroxy group or a thiol group; and Z represents hydrogen or has the same meaning as that of M.

Such side chains are preferably carried by polymeric fibres selected from polyolefins, poly(haloolefins), poly(vinylalcohol), polyesters, polyamides, polyacrylics, protein fibres and cellulosic fibres (for example cotton, viscose and rayon). Polyolefins are especially preferred, particularly polyethylene and polypropylene.

When side chains are grafted onto the base polymeric bodies a preferred process is one using irradiation, in an inert atmosphere, with immediate delivery to irradiated bodies of acrylic acid. Preferably the radiation is electron beam or gamma radiation, to a total dose of 10-300 kGy, preferably 20-100 kGy. The acrylic acid is preferably of concentration 20-80 vol %, in water, and the temperature at which the acrylic acid is supplied to the irradiated polymeric bodies is preferably an elevated temperature, for example 30-80° C. Preferably the base polymeric bodies are polyethylene, polypropylene or cellulosic fibres.

In a preferred feature the water-insoluble agent comprises ion exchange resin, preferably cation exchange resin. Cation exchange resins may comprise strongly and/or weakly acidic cation exchange resin. Further, resins may comprise gel-type and/or macroreticular (otherwise known as macroporous)-type acidic cation exchange resin. The exchangeable cations of strongly acidic cation exchange resins are preferably alkali and/or alkaline earth metal cations, and the exchangeable cations of weakly acidic cation exchange resins are preferably H⁺ and/or alkali metal cations.

Suitable strongly acidic cation exchange resins include styrene/divinyl benzene cation exchange resins, for example, styrene/divinyl benzene resins having sulfonic functionality and being in the Na⁺ form such as Amberlite 200, Amberlite 252 and Duolite C26, which are macroreticular-type resins, and Amberlite IR-120, Amberlite IR-122, Amberlite IR-132, Duolite C20 and Duolite C206, which are gel-type resins. Suitable weakly acidic cation exchange resins include acrylic cation exchange resins, for example, Amberlite XE-501, which is a macroreticular-type acrylic cation exchange resin having carboxylic functionality and being in the H⁺ form, and Amberlite DP1 which is a macroreticular-type methacrylic/divinyl benzene resin having carboxylic functionality and being in the Na⁺ form.

Other forms of water-insoluble ion exchange agents can be used—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:
0.8-1.5 Na₂O.Al₂O₃.0.8-6 SiO₂
and incorporate some water. Preferred sodium aluminosilicates within the above formula contain 1.5-3.0 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in U.S. Pat. No. 4,464,839 and U.S. Pat. No. 4,820,439 and also referred to in EP-A-551375.

These materials are defined in U.S. Pat. No. 4,820,439 as being crystalline layered, sodium silicate of the general formula
NaMSiₓO₂ₓ₊₁.YH₂O
where

M denotes sodium or hydrogen,

x is from 1.9 to 4 and y is from 0 to 20.

Quoted literature references describing the preparation of such materials include Glastechn. Ber. 37,194-200 (1964), Zeitschrift für Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water, also covered are salts of zinc which have also been shown to be effective water-softening agents.

In principle, however, any type of insoluble, calcium-binding material can be used.

Preferably the water-insoluble water-softening agent is also able to bind magnesium ions as well as calcium ions.

Water-Soluble Water-Softening Agents

A water-soluble water-softening agent may be present in the water-softening composition in an amount of more than 1%, 5%, 10%, 20%, 30%, 40%, 50%, 60%, 70%, 80%, 90% and 95% wt thereof. Desirable maximum amounts are less than 95%, 90%, 80%, 70%, 60%, 50%, 40%, 30%, 20% and 10% wt, based on the total weight of the water-softening composition. A preferred range is 20-80%, more preferably 40-70%, and most preferably 50-60%.

By the term “water-soluble” we include agents that are water dispersible. Such agents include

1) Ion capture agents—agents which prevent metal ions from forming insoluble salts or reacting with surfactants, such as polyphosphate, monomeric polycarbonates, such as citric acid or salts thereof.

2) Anti-nucleating agents—agents which prevent seed crystal growth, such as polycarbonate polymers, such as polyacrylates, acrylic/maleic copolymers, phosphonates, and acrylic phosphonates and sulfonates.

3) Dispersing agents—agents that keep crystals suspended in solution, such as polyacrylate polymers.

Preferred Water-Softening Compositions

Preferred water-softening compositions contain at least one of the following:
(1) citric acid, preferably 1-30% wt, especially 5-20% wt; and
(2) trisodium citrate, preferably 5-80% wt, especially 40-60% wt.

Preferably both such compounds are present, within the ranges stated.

Preferred water-softening compositions may contain at least one of
(3) acrylic acid copolymer or, preferably, homopolymer, preferably 5-60% wt, especially 20-40% wt;
(4) cationic ion exchange resin, preferably 1-30% wt, especially 3-10% wt; and
(5) esterquat, preferably 0.1-5% wt, especially 0.2-2% wt;

Preferred water-softening compositions may contain
(6) fusible/re-settable binder, preferably 5-30% wt, especially 8-20% wt.

In each case the amount stated is based on the total weight of the water-softening composition, subject preferably to the total of such compounds (1) to (6) as are present being substantially 100% wt of the water-softening composition (as is preferred) or less (when there are other components present)—but preferably at least 80% of the water-softening composition. A preferred water-softening composition contains:

component (1) or (2), most preferably (1) and (2);

at least one of component (3) or (4) or (5), more preferably (3) and (4), or (4) and (5), or (3) and (5), most preferably (3) and (4) and (5); and component (6).

Forming an Open Sachet

Sachet forming can be done in an horizontal or in a vertical plane, either from a single roll of water permeable water-insoluble material that is folded to form the walls of the sachet or from two or more rolls of water permeable water insoluble material that are joined together to form the walls of the sachet.

Machine assemblies for sachet forming, filling and sealing can be sourced from, VAI, IMA, Fuso for vertical machines; Volpack, Iman Pack for horizontal sachet machines; Rossi, Optima, Cloud for horizontal pod machines.

Filling the Open Sachet

The open sachet is preferably configured as a pocket or pouch, preferably sealed or otherwise closed on three edges, and which can be filled through an edge, for example the fourth, open, side. The open sachet may preferably be formed by folding a single web and sealing it transversely to the fold at two spaced-apart positions, leaving one edge open.

Filling of the open sachet can be done with a variety of volumetric devices, such as a dosing screw or as a measuring cup. Typical dosing accuracy required at constant product density is ±1% wt preferably, ±5% wt minimum.

Filling devices are supplied by the companies mentioned above as part of the machine package.

Feedback control mechanisms acting on the speed of the dosing screw or on the volume of the measuring cup can be installed to maintain high dosing accuracy when the product density changes.

Sealing

Seal strength is important, as the sachet must not open during the wash cycle or other type of cleaning or water-softening operation, otherwise any water insoluble ingredients might soil the items washed.

A seal strength of at least 5N/20 mm, preferably at least 10N/20 mm and most preferably at least 15N/20 mm according to test method ISO R-527 measured before the wash sealed sachet is subjected to a wash. The strength of any seal is very much dependent on the materials used and the conditions of the sealing process, for example the following conditions are used to generate good quality seals on 100% non woven polypropylene (PP) such as LS3440 by Freudenberg or Berotex PP 40 gsm by BBA or Axar A by Atex
heat sealing, preferably using flat sealing bars, 5 mm by 100 mm, Teflon coated stainless steel, typically 1 sec at 150° C.±1° C. at 20 kg/cm² actual sealing pressure, as achieved on a bench scale Kopp heat sealer and on the heat sealing devices of most of the machine suppliers mentioned before;
ultrasound sealing, preferably using grooved sealing bars, 5 mm by 150 mm, pattern with diagonal grooves at 45 degrees to the side of the seal, pitch of 15 mm and bar width of 5 mm with a nominal seal area coverage of 33%, 0.1 to 0.3 s at 20 kHz and 70 microns vibration amplitude, actual sealing pressure between 10 and 60 kg/cm2, typical absorbed power 300 to 1200 W, typical absorbed energy 30 to 180 W, using ultrasound sealing equipment produced by companies like Mecasonic or Branson or Herrmann or Sonic or Dukane or Sonobond.;
glue sealing, e.g. applying 10 g/m2 of hot melt glue like Prodas 1400, PP, from Beardow Adams. Polyethylene (PE) or polyamides or polyurethanes or UV curable acrylics glues or epoxy resins can be used as well.
   Cutting the Closed Sachet

Cutting can be achieved through rotary knives, scissors, vibrating blunt knives and lasers.

Distributing Evenly the Water-Softening Composition

Distribution of the water-softening composition in the sachet can be achieved by the use of customised powder distribution devices based on a combination of vibrating belts and/or pressure rollers.

Typical sources of vibrations are electromagnetic orbital vibrators, rotating eccentric disks and crankshaft mechanisms. Suitable vibration frequencies are between 50 and 2000 Hz, preferably between 200 and 1000 Hz. Suitable vibration amplitudes are between 0.2 and 10 mm, preferably between 1 and 5 mm. Suitable residence times of the sachet between the belts or rollers are between 0.5 and 30 sec, preferably between 2 and 20 sec. Suitable pressures of the sachet between the belts or rollers are between 0.01 and 2 kg/cm2, preferably between 0.2 and 1 kg/cm2.

Fixing the Water-Softening Composition

Preferably, this is achieved by heating the binder, when present, in the composition:
by convective heat, for example by the use of an hot air oven, typical residence times around 90 seconds for 130° C. air may be needed. Pressures of 0.01 to 1 kg/cm2, preferably 0.05 to 0.3 kg/cm2 facilitate the flow of the binder throughout the product mass;
by conductive heat, for example by the use of a heated pressure belt or belt to drum or drum to drum arrangement, typical residence times between 20 and 40 seconds for 130° C. heating elements, pressure on top of sachet of at least 100 g/cm², preferred 200 g/cm² may be applied also;
by IR heating or UV curing, for selective heating or polymerisation of specific binders, e.g. with 10-30 seconds under an IR radiation with a maximum emission at 2 microns wavelength.

It is possible to perform the step of distributing and fixing at the same time, for example, by the use of heated pressure rollers and/or belts.
A key feature for the selection of the binder, actives and sachet packaging is that:
T_{melting}binder<T_{stability}actives and T_{melting}binder<T_{melting}sachet packaging
Cooling can be used and as is preferably achieved using dry/cool air (T<20° C., RH<50%) resulting in lower sachet temperatures, preferably below 30° C.
   Web Materials

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6,093,474, EP 0708628 and EP 380127A.

Conveniently the web is a non-woven. Processes for manufacturing non-woven fabrics can be grouped into four general categories leading to four main types of non-woven products, textile-related, paper-related, extrusion-polymer processing related and hybrid combinations
Textiles. Textile technologies include garnetting, carding, and aerodynamic forming of fibres into selectively oriented webs. Fabrics produced by these systems are referred to as drylaid nonwovens, and they carry terms such as garnetted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.
In general, textile-technology based processes provide maximum product versatility, since most textile fibres and bonding systems can be utilised.
Paper. Paper-based technologies include drylaid pulp and wetlaid (modified paper) systems designed to accommodate short synthetic fibers, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.
Extrusions. Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fiber structures simultaneously are formed and manipulated.
Hybrids. Hybrids include fabric/sheet combining systems, combination systems, and composite systems. Combining systems employs lamination technology or at least one basic nonwoven web formation or consolidation technology to join two or more fabric substrates. Combination systems utilize at least one basic nonwoven web formation element to enhance at least one fabric substrate. Composite systems integrate two or more basic nonwoven web formation technologies to produce web structures. Hybrid processes combine technology advantages for specific applications.

The wall of the container may itself act as a further means for modifying the water, for example by having the capability of capturing undesired species in the water and/or releasing beneficial species. Thus, the wall material could be of a textile material with ion-capturing and/or ion-releasing properties, for example as described above, such a product may be desired by following the teaching of WO 02/18533 that describes suitable materials.

Packaging

Preferably the product is held in a packaging system that provides a moisture barrier.

The packaging may be formed from a sheet of flexible material. Materials suitable for use as a flexible sheet include mono-layer, co-extruded or laminated films. Such films may comprise various components, such as poly-ethylene, poly-propylene, poly-styrene, poly-ethylene-terephtalate or metallic foils such as aluminium foils. Preferably, the packaging system is composed of a poly-ethylene and bi-oriented-poly-propylene co-extruded film with an MVTR of less than 30 g/day/m². The MVTR of the packaging system is preferably of less than 25 g/day/m^{2,} more preferably of less than 22 g/day/m^{2.} The film may have various thicknesses. The thickness should typically be between 10 and 150 μm, preferably between 15 and 120 μm, more preferably between 20 and 100 μm, even more preferably between 30 and 80 μm and most preferably between 40 and 70 μm.

Among the methods used to form the packaging over the container are the wrapping methods disclosed in WO92/20593, including flow wrapping or over wrapping. When using such processes, a longitudinal seal is provided, which may be a fin seal or an overlapping seal, after which a first end of the packaging system is closed with a first end seal, followed by closure of the second end with a second end seal. The packaging system may comprise re-closing means as described in WO92/20593. In particular, using a twist, a cold seal or an adhesive is particularly suited. Alternatively the packaging may be in the form of a sealable bag that may contain one or more (greater than ten but less than forty) sachets.

MVTR can be measured according to ASTM Method F372-99, being a standard test method for water vapour transfer rate of flexible barrier materials using an infrared detection technique.

In a preferred water-softening method a product of the invention may be disposed in a clothes washing machine throughout the wash and rinse cycles, for example by being placed in the machine's drum with laundry to be washed.

In a further definition the invention may be stated to be a process for the preparation of a water-softening product, the process comprising
(a) folding a sheet of water-permeable water-insoluble sheet material;
(b) supplying a water-softening composition to the folded sheet, the water-softening composition comprising at least one water-softening agent and a fusible binder;
(c) sealing the open sides of the sheet to form an enclosure containing the water-softening composition;
(d) supplying heat to the enclosures to fuse the binder, and cooling it to form a “cake” of water-softening composition spread across the inside of the interior of the enclosure; and
(e) cutting the sheet or enclosure to form a sachet, the cutting being carried out at any suitable stage of the process.

In a further definition the invention may be stated to be a water-softening product formed by a process as described in the previous paragraph, wherein the sachet is of size in the range 80 to 300 cm², and contains at least 5 g of water-softening composition, and wherein the cake breaks in use creating loose granular insoluble materials that can move freely inside the sachet.

A product may be disposed in a clothes washing machine throughout the wash and rinse cycles, for example by being placed in the machine's drum with laundry to be washed.

In this specification percentage values, indicated by the symbols % or % wt, denote weight of the stated component expressed as a percentage of the total composition weight unless otherwise stated.

The invention will now be described, by way of example, with reference to the following embodiments.

Sachets were made with the following contents:

| | Example | | |
|---|---|---|---|
| Actives in | 1 | 2 | 3 |
| Sachet | Amt (g) | Amt (g) | Amt (g) |
| Acrylic acid | 5.00 | 4.2 | 3.84 |
| polymer | | | |
| Citric Acid | 2.85 | 2.2 | 5.43 |
| Phosphonate | 0.10 | — | 0.10 |
| chelating agent | | | |
| Cationic | 3.00 | 1.2 | 3.00 |
| Exchange | | | |
| Resin | | | |
| Water | 0.25 | | 0.80 |
| absorbent | | | |
| polymer | | | |
| Esterquat | 0.50 | 0.2 | 0.09 |
| Trisodium | — | 6.7 | — |
| citrate | | | |
| Polyethylene | — | 2.0 | 1.9 |
| binder | | | |
| Ethyl vinyl | 1.5 | | |
| acetate binder | | | |
| Total (grams) | 13.2 | 16.15 | 15.16 |

The webs were made of polypropylene nonwoven sheet material Leutrasil™ from Freudenberg Nonwovens. The sachets were made by folding a single web into a V-shape in a vertical plane, using ultrasonic sealing to make two spaced-apart seals extending transversely up to the fold line to form a pocket-like open sachet, feeding the particulates into the open sachet, sealing the sachet along the remaining edge requiring closure, by means of ultrasonic sealing, and cutting to form the individual sachets. They were then laid horizontally and vibrated until flat, then heated, and cooled. The resulting sachets were square, 12 cm×12 cm, and contained their contents as a cake of consolidated particulates, adhered to the two sheets forming the sachet.

Ten sachets were held in a bag made from the following material and stored in a standard non-waxed cardboard box. In addition ten identical sachets were stored in the same standard non-waxed cardboard box but without being packed in the bag. Standard storage conditions were used, which may be defined as 25° C. at 50% relative humidity for 6 weeks. After storage the sachets were inspected for visible degradation and tested for performance.

Packaging Description

The sachets were made from reeled polythene film, 380 mm wide.

| | | THICKNESS |
|---|---|---|
| GENERIC NAME | MANUFACTURER | (μm) |
| Polyethylene | ASPLA, | 60 |
| LDPE-LLDPE | Torrelavega | |
| | (Santander, | |
| | Spain) | |

| | |
|---|---|
| PERFORMANCE | Value |

| 1.1 | Tensile strength (Machine Direction) | >20 | N/MM2 |
|---|---|---|---|
| 1.2 | Coefficient of friction | — | |
| | Internal | <0.25 | |
| | External | <0.25 | |
| 1.3 | Barrier properties | | |
| | Oxygen transmission | 4000 | cc/m²/24 hr |
| | Water vapour transmission | 20 | grs./m²/24 hr |

| | Supplier |
|---|---|
| Supplier's Name | Aspla |
| Site of Manufacturer | Torrelavega |
| | (Santander) |

1. A process for the preparation of a water-softening product, the process comprising the steps of:
a) forming an open sachet from one, two or more water permeable water-insoluble webs;
b) filling the open sachet with a water-softening composition; and
c) c) sealing the sachet.

2. A process as claimed in claim 1, further comprising the process step of:
d) cutting the closed sachet formed from a water permeable water-insoluble web(s).

3. A process as claimed in claim 1 comprising the additional step of distributing evenly the water-softening composition through the sachet.

4. A process according to claim 1 comprising the additional process step of:
fixing the water-softening composition to itself and/or the wall(s) of the sachet.

5. A process according to claim 1 comprising the further process step of:
packaging the sachet into a moisture impermeable package.

6. A process according to claim 1 wherein the water-softening composition comprises at least one water-softening agent and a fusible binder, and wherein the process includes supplying heat to the closed sachet to fuse the binder, and cooling it to form a cake of water-softening composition inside the sachet.

7. A water-softening product comprising a container containing a water-softening composition, the container being formed by the closing of a sachet formed from one, two or more water permeable water-insoluble webs.

8. A water-softening product as claimed in claim 7 wherein the water-softening composition contains at least one water-softening agent which is substantially water-insoluble.

9. A water-softening product according to claim 7 wherein the container is a flat container.

10. A water-softening product according to claim 7 wherein the or each web is a woven or non-woven material.

11. A water-softening product formed by a process according to claim 1, wherein the sachet is of size in the range 80 to 300 cm², and contains at least 5 g of water-softening composition, and wherein the cake breaks in use creating loose granular water-insoluble material that can move freely inside the sachet.

12. A method of softening water comprising:
contacting hard water with a product according to claim 7.

13. A method as claimed in claim 12 wherein the method is a method used in a ware washing machine.

14. A water-softening product according to claim 7 wherein at least one water-softening agent within the water-softening composition is a cation exchange resin.
